(19) United States
(12) Patent Application Publication
(10) Pub. No.: US 2026/0167125 A1
(43) Pub. Date: Jun. 18, 2026

(54) CONNECTION ARRANGEMENT

(71) Applicant: Brose Fahrzeugteile SE & Co. Kommanditgesellschaft, Bamberg, Bamberg (DE)

(72) Inventor: Stefan KAISER, Altendorf (DE)

(21) Appl. No.: 19/419,879

(22) Filed: Dec. 15, 2025

(30) Foreign Application Priority Data
Dec. 17, 2024 (DE) 102024212037.5

(51) Int. Cl. B60R 13/02

(52) U.S. Cl. CPC B60R 13/0243

(57) ABSTRACT

A connection arrangement including at least a first component and a second component, which in each case have a first through-opening, which are arranged in a manner axially aligned with one another in a final assembly position and are penetrated by a connection element joining the components. A second through-opening of the second component, which is arranged to be adjacent to its first through-opening. A latching hook projecting axially upwards from the first component and having a radially flexible latching tab and a latching lug at its free end. The latching hook is latched in a pre-assembly position in an axially form-fitting and/or force-fitting manner to an opening edge of the second through-opening.

### CROSS-REFERENCE TO RELATED APPLICATION

This application claims priority pursuant to 35 U.S.C. 119(a) to German Patent Office Application No. 102024212037.5, filed Dec. 17, 2024, which application is incorporated herein by reference in its entirety.

### FIELD OF THE INVENTION

The invention relates to a connection arrangement comprising at least a first component and a second component, which in each case have a first through-opening, and which, in a final assembly position, are arranged in a manner axially aligned with one another and are penetrated by a connection element joining the components. The invention further relates to a door assembly having such a connection arrangement and a door module for such a door assembly.

### BACKGROUND

A door body of a vehicle door generally has an outer door panel forming the outer skin of the vehicle door and an inner door panel, on the interior side of the vehicle, connected to the outer door panel, between which a cavity is formed as an assembly space, in which functional elements of the vehicle door, such as a window lifter, a door lock, an airbag, or the like, are arranged.

The functional elements of the vehicle door are conventionally inserted from the inner side of the door through an assembly opening arranged in the inner door panel into the cavity or assembly space between the outer door panel and the inner door panel and brought into their functional positions.

For simplified assembly of the functional components in the vehicle door, it is possible to pre-assemble such functional components on a carrier plate, also called a functional carrier or unit carrier. The equipped carrier plate is fastened as a so-called door module to the door shell (door frame, inner door panel) while covering a compartment, which also serves as an assembly opening, of the door frame (inner door panel). The door module, which is designed as a carrier plate equipped with the window lifter, also serves to separate a wet space formed between the outer door skin (the outer door panel) and the door module from a dry space of the vehicle door formed between the door module and the inner door trim (the inner door panel).

The fastening of the door module or the unit carrier to a body part of a motor vehicle or to the inner door panel (door frame) of the vehicle door is usually carried out by means of a few connection elements, which are already pre-mounted on the door module and are inserted into corresponding through-openings in the unit carrier. The connection elements are designed as screw elements or as bayonet elements, as described, for example, International Patent Application No. WO 2021/140027 A1 or German Patent Application No. 10 2021 214 841 A1.

During the assembly of the door module on the inner door panel or door shell, the connection elements are, for example, pushed through the passage openings of the inner door panel (as the second component) that are aligned with the passage openings of the door module (as the first component) and subsequently rotated or turned into an end position. The door module and the inner door panel are clamped against one another, so that the door module is reliably held to the inner door panel.

Particularly in the case of unit carriers made of plastic, it can happen that, due to component distortion, the unit carrier protrudes too far from the door shell during assembly, so that screw or bayonet-type connection elements cannot engage in the passage openings in the door shell.

### SUMMARY

Here and in the following, the term “component distortion” is to be understood to mean an undesirable deviation in shape or deformation (deformation, warpage) of a component that may occur during manufacture, transport, or assembly and that causes the component to deviate from its intended geometric dimensions or tolerances.

In the case of a component-warped unit carrier, it is therefore necessary to press and hold the unit carrier in position by hand during assembly on the door shell. If the unit carrier is not held, there is a risk that the unit carrier will fall out of the vehicle door during assembly, thereby damaging the unit carrier and/or the functional components pre-mounted on it.

The invention is based upon the object of providing a particularly suitable connection arrangement for joining two components. A drop-out or loss-prevention safeguard is to be implemented to ensure that the components do not have to be held and pressed together by hand during assembly. The invention is further based upon the object of specifying a particularly suitable door assembly with such a connection arrangement, along with a particularly suitable door module.

Regarding the connection arrangement, the object is achieved according to the invention with the features of Claim 1, and regarding the door assembly with the features of Claim 8, and with regard to the door module with the features of Claim 9. Advantageous embodiments and further developments are the subject matter of the dependent claims (subclaims). The advantages and embodiments mentioned with regard to the connection arrangement can also be applied to the door assembly and/or the door module, and vice versa.

Here and in the following, the conjunction “and/or” is to be understood in such a way that the features linked by this conjunction can be formed both together and as alternatives to one another.

The connection arrangement according to the invention has at least a first component and a second component. The first and second components are components of a motor vehicle door. Preferably, the first component is a door module or its unit carrier, and the second component is a door shell of the vehicle door.

Here and in the following, a “unit carrier” is to be understood to mean in particular a flat component on which door components or functional elements of the vehicle door, such as a window lifter or the window guide(s), can be (pre-)mounted. The unit carrier is made, for example, of a metal, in particular steel or an aluminum alloy. Preferably, the unit carrier is made at least in portions from a composite or plastic material. This means, for example, that one part of the unit carrier or a plurality of parts of the unit carrier are made of a plastic material. Preferably, a large part of the unit carrier, i.e., more than 40% or 50% of the unit carrier, is made of the plastic material.

Here and in the following, the term “door shell” is to be understood to mean in particular a body part of a vehicle door-for example, a side door of a motor vehicle. Here, the door shell is designed as a metal or sheet metal part. The door shell has a door frame having an outer door part (outer door panel) forming the outer door skin of the vehicle door and having an inner door part (inner door panel) on the interior side of the vehicle, between which a cavity is formed as an assembly space.

Thus, the connection arrangement is particularly provided and configured to connect a plastic component (first component) at risk of component distortion to a metal component (second component) in a pre-assembly position.

According to the invention, the connection arrangement is provided and configured to join the components in a pre-assembly position, so that subsequent final assembly for realizing a final assembly position is simplified. Thus, the assembly of the components is divided into pre-assembly and final assembly.

The components in each case have a first through-opening. The first through-openings of the first and second components preferably feature substantially the same opening cross-section. Here and in the following, a “through-opening” is to be understood to mean a hole-like passage opening or an opening that completely penetrates the particular component and thus makes direct passage possible from one side of the component to the opposite side of the component.

The first through-openings are provided and configured to make a stable component connection possible in the final assembly position. In the final assembly position, the first through-openings are arranged in a manner axially aligned with one another and are penetrated by a connection element that joins the components. The first through-openings thus form the fastening points of the components to one another. Here, the connection element is usually not itself part of the connection arrangement but is designed to be separate. However, the connection element is, for example, pre-mounted on the first component and at least partially inserted into its first through-opening.

The connection element is provided and configured to mechanically connect the two components in the final assembly position. The connection element is effective, for example, as a screw element or preferably in the manner of a bayonet lock and can therefore also be referred to as such. A bayonet lock, for example, is used as a connection element, as described, for example, in the International Patent Application No. WO 2021/140027 A1 or German Patent Application No. DE 10 2021 214 841 A1. The contents of the disclosure, in particular the claims (with associated explanations), are hereby expressly incorporated into this application. Here, the connection element is pre-mounted on the first component and, in the final assembly position, passes through the axially aligned first passage openings of the components and is rotated or twisted into a final angular position relative to an insertion angular position to establish the connection.

The following provides information with regard to the spatial directions, in particular with respect to the arrangement of the first through-openings in the final assembly position. Here and in the following, the term “axial” or an “axial direction” is understood to mean in particular a direction parallel to (coaxial with) a center axis passing through the first through-openings, i.e., perpendicular to the end faces of the components. Accordingly, here and in the following, “radial” or a “radial direction” is understood to mean in particular a direction oriented to be perpendicular (transverse) to the center axis along a radius of the first through-openings. Here and in the following, the term “tangential” or a “tangential direction” is understood to mean in particular a direction along the circumference of the first through-openings (circumferential direction, azimuthal direction), i.e., a direction perpendicular to the axial direction and to the radial direction.

Here, the axial direction is parallel to the joining direction of the components, i.e., the direction along which the components are joined together. Here, the joining directions for pre-assembly and final assembly are oriented parallel to one another. Thus, the components are joined or connected together axially for both pre-assembly and final assembly.

For the pre-assembly of the components according to the invention, the second component has a second through-opening that, with a latching hook of the first component, establishes a joining connection that secures the pre-assembly position. In other words, the first component of the connection arrangement has a latching hook that engages or hooks into the second component during pre-assembly. In particular, the components are thus joined together in the pre-assembly position by an axially form-fitting and/or force-fitting latching or clipping connection. As a result, a drop-out or loss-prevention safeguard is implemented along the axial direction or joining direction, which ensures that the components do not have to be held and pressed against one another by hand during final assembly. Thus, a particularly suitable connection arrangement is achieved. In particular, this makes a simple and reliable final assembly possible even if the first component is distorted.

Here, the second through-opening of the second component is arranged to be adjacent to, i.e., close to or at a short distance from, its first through-opening. Thus, the second through-opening is arranged in a manner radially offset or distanced from the first through-opening.

The second through-opening has, for example, an opening cross-section that differs from that of the first through-opening. Preferably, the second through-opening is designed as a round hole.

The latching hook is arranged to be adjacent to the first through-opening of the first component. In particular, the radial arrangement of the latching hook relative to the first through-opening of the first component substantially corresponds to the radial arrangement of the first and second through-openings of the second component.

The latching hook is preferably formed integrally, i.e., in one piece or monolithically, with the first component and projects axially upwards from it. The latching hook has an axially extending latching tab, which is provided at its free end with a latching lug of, for example, wedge-shaped design. The latching hook or the latching tab is designed to be radially flexible in bending, which means that the latching tab is designed to be able to be elastically deflected in the radial direction against a restoring force. The latching tab is thus designed in particular to be resilient; in other words, the latching tab is configured as a spring tab. In the case of a first component designed as a plastic component, the integrally formed latching hook is thus designed as a plastic spring.

For pre-assembly, the first component is positioned relative to the second component in such a way that the latching hook is arranged in a manner axially aligned with the second through-opening of the second component, wherein the latching tab is arranged within an inner circumference, projected onto the first component, of the second through-opening, and the latching lug is arranged at least partially outside this inner circumference. Subsequently, for example, the first component is moved axially in the direction of the second component, so that the latching hook engages in the second through-opening. The latching lug slides along the opening edge of the second through-opening and is thus moved radially inwards, i.e., in the direction of a center axis of the second through-opening. As a result, the latching tab is deflected radially and mechanically tensioned, whereby the latching lug is moved back radially outwards due to the resulting restoring force as soon as the latching lug has completely passed through the second through-opening. As a result, the latching lug engages behind the opening edge of the second through-opening, so that the latching hook is latched or clipped in an axially form-fitting and/or force-fitting manner to the opening edge of the second through-opening in a pre-assembly position. The final assembly of the components, i.e., the transfer of the components from the pre-assembly position to the final assembly position, is subsequently carried out via the first through-openings and the connection element.

Here and in the following, a “form-fit” or a “form-fitting connection” between at least two interconnected parts is understood in particular to mean that the interconnected parts are held together at least in one direction by a direct interlocking of contours of the parts themselves or by an indirect interlocking via an additional connection part. Thus, the “blocking” of relative movement in this direction occurs due to the shape of the parts.

Here and in the following, a “force-fit” or a “force-fitting connection” between at least two interconnected parts is understood in particular to mean that the interconnected parts are prevented from sliding off one another due to a frictional force acting between them. If there is no “connecting force” that causes this frictional force (meaning the force that presses the parts against one another, e.g., a screw force or the weight itself), the force-fitting connection cannot be maintained and can thus be released.

Here and in the following, a “pre-assembly position” is to be understood to mean, in particular, a pre-fixing of the first component to the second component, i.e., a preliminary holding or fastening of the first component in the sense of pre-assembly or pre-positioning. The form-fitting and/or force-fitting latching connection implemented here is, with regard to its stability, provided in particular only with regard to assembling the first component on the second component in order to prevent the first component from undesirably falling out or sliding out of the second component. The pre-fixed latching connection between the latching hook and the second through-opening is not provided or suitable for fixing the components together in a stable, permanent, and reliable manner. Thus, the pre-assembly position is merely a preliminary positioning for the subsequent final assembly step via the connection element and the first through-openings.

Here and in the following, a “final assembly position” is to be understood to mean in particular the final position of the components that they assume after completion of the (final) assembly process. The final assembly position describes the state in which the components are fastened to one another in a stable, permanent, and reliable manner. In the final assembly position, the connection element passes through both first through-holes and connects the components to one another or clamps them against one another.

In an advantageous embodiment, the latching hook is dimensioned in such a way that, in the pre-assembly position, an axial distance between the components, i.e., an axial clear width, is less than or equal to a penetration length of the connection element. Preferably, an axial length of the latching hook and its radial position relative to the first through-opening are dimensioned in such a way that the first component is held close to the second component in the pre-assembly position, so that the connection element (screw element, bayonet lock) can penetrate the first through-openings of both components. As a result, it is ensured that the connection element can connect the two components together or clamp them against one another in the pre-assembly position.

In a preferred embodiment, an axially elastically compressible sealing element is arranged on the first component. Here, the sealing element is positioned in a manner radially offset to the first through-opening and the latching hook. Here, when the first component is designed as a door module or unit carrier, the sealing element is arranged, for example, as a carrier seal on the wet-space side, circumferentially along an outer edge of the unit carrier, in order to ensure a seal between the unit carrier and the door shell or between the wet space and the dry space in the assembled state (final assembly position). The sealing element is designed, for example, as a PU foam seal (PU: polyurethane) or as a TPE seal (TPE: thermoplastic elastomer).

In the pre-assembly position, the sealing element is at least partially axially compressed. As a result, the sealing element in the pre-assembly position produces an axial restoring force, which pushes the first component away from the second component, so that the axial form-fit of the latching hook at the opening edge is secured by means of a tensile stress. Due to the compressible sealing element, an axially force-fitting fixation of the form-fitting engagement of the latching lug is thus achieved.

As a result, a particularly stable pre-assembly position is made possible, such that final assembly is further simplified.

Furthermore, the compressibility of the sealing element also makes (radial) tool access to the latching hook possible by inserting a tool from the component edge to the component center between the sealing element and the second component. As a result, a radial deflection of the latching tab is possible, so that the latching connection can be released in the pre-assembled state using a flat unlocking tool. In other words, the hook lock of the pre-assembly can be released again using a tool.

An additional or further aspect of the invention provides that the first component have a support wall projecting axially upwards for delimiting a radial deflection of the latching tab. Here, the support wall is positioned in a manner radially distanced from the latching hook and extends substantially parallel to the latching tab. The radial distance between the latching tab and the support wall is dimensioned in such a way that, during pre-assembly, an impermissible deflection or deformation of the latching tab beyond the elastic range is prevented by the latching tab coming to rest against the support wall. As a result, damage to the latching tab during pre-assembly is prevented, so that it is ensured that the components are stably aligned with and held relative to one another in the pre-assembly position.

In a possible further development, the latching tab on a rear side facing the support wall has an extension projecting axially upwards as a mechanical stop on the support wall. For example, the extension is formed on the free end in the region of the latching lug on the latching hook. As a result, a particularly controlled and stable deflection delimitation for the latching hook is achieved.

The support wall projecting upwards is formed integrally, i.e., in one piece or monolithically, with the first component. To stabilize and stiffen the support wall, one conceivable embodiment provides for the support wall to have at least one axially extending reinforcing rib on a rear side facing away from the latching tab.

In one preferred embodiment, the latching hook and the support wall are seated radially in the second through-opening in a form-fitting and/or force-fitting manner in the pre-assembly position, so that the first through-openings of the components are held in a defined position relative to one another. As a result, final assembly is further simplified. In order to improve the hold in the second through-opening, the support wall has, for example, a curved or arched cross-section, which is supported, for example, via a plurality of reinforcing ribs on the inner circumference of the second through-opening.

The door assembly according to the invention is provided for a vehicle door, in particular for a side door of a motor vehicle and is suitable and configured therefor. The door assembly has a door shell, in particular a door frame or an inner door part, and a mounted or mountable door module. The door module has a unit carrier (door module carrier), on which at least one door component of the vehicle door is pre-mounted.

The door shell or the inner door part has an assembly opening for an assembly space of the vehicle door. Here, the assembly opening is provided and configured to be covered (concealed) by the door module or the unit carrier. In other words, the door module can be mounted on the door shell or on/at the assembly opening in such a way that the assembly opening is covered by the door module, in particular by its unit carrier. Here, in the assembled state, the door module closes the assembly opening, wherein the unit carrier preferably realizes a wet/dry space separation of the vehicle door.

For fastening or assembling the door module to the door shell, at least one connection arrangement as described above is provided, wherein the unit carrier forms the first component and the door shell forms the second component. As a result, a particularly suitable door assembly is achieved, in which the unit carrier can be reliably and easily (finally) mounted to the door shell without manual holding, even in the event of component distortion.

Here, the connection arrangement is arranged, for example, at the bottom of the unit carrier, i.e., in a region, facing the ground in the assembled state, of the unit carrier, so that the unit carrier is prevented from slipping downwards out of the vehicle door during final assembly.

For example, it is possible that the door assembly has more than one connection arrangement. In other words, a number of connection arrangements, i.e., at least two connection arrangements, are arranged on the door shell and the unit carrier, so that the components are held in the pre-assembly position at a plurality of fastening points. As a result, on the one hand, the pre-assembly position is held particularly stably, so that a particularly simple final assembly is possible. On the other hand, as a result, the mechanical demands upon the individual connection arrangements are reduced, in particular upon the individual latching hooks, so that they can be designed in a simpler and more cost-effective manner.

The door module according to the invention is provided for a door assembly as described above and is suitable and configured therefor. Here, the door module has a unit carrier and at least one door component pre-mounted on it. Here, the door module or its unit carrier is designed as a first component for a connection arrangement described above. For this purpose, the unit carrier has a first through-opening that, in a final assembly position, is arranged in a manner axially aligned with a first through-opening of a door shell of the door assembly and is penetrated or can be penetrated by a connection element. The unit carrier further has a latching hook projecting axially upwards having a radially flexible latching tab and a latching lug at its free end, wherein the latching hook is or can be latched in a pre-assembly position in an axially form-fitting and/or force-fitting manner to an opening edge of a second through-opening of the door element. As a result, a particularly suitable door module is achieved, which can be easily mounted on a door shell.

### BRIEF DESCRIPTION OF THE DRAWINGS

An exemplary embodiment of the invention is explained in more detail below with reference to a drawing. In the figures:

FIG. 1 shows a perspectival view of a door assembly having a door shell and a door module;

FIG. 2 shows a perspectival view of the door module with a view of a wet-space side;

FIG. 3 shows, in a plan view in sections, the door module with a view of the wet-space side;

FIG. 4 shows, in a plan view in sections, a connection arrangement of the door assembly; and,

FIG. 5 to FIG. 7 show, in successive sectional views, a pre-assembly of the door assembly.

### DETAILED DESCRIPTION OF THE INVENTION

Parts and dimensions corresponding to one another are consistently provided with the same reference signs in all figures.

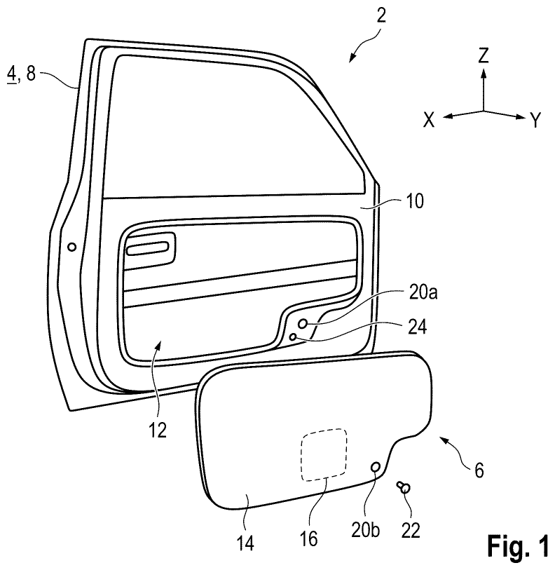

FIG. 1 shows a door assembly 2 for a vehicle door designed as a side door, in particular as a swing-hinged door, of a motor vehicle, in a partially disassembled state. The door assembly 2 has a door shell 4 as a door body, and a door module 6.

The door shell 4 has a door frame 8 as a door body for accommodating functional and door components of the vehicle door. The door frame 8 an inner door part (inner door panel) 10, on the interior side of the vehicle, which has an assembly opening 12 as access to an assembly space of the door frame 8. The assembly opening 12 is closed in a (final) assembled state by a unit carrier 14 of the door module 6. In the (final) assembled state, the unit carrier 14 acts as a wet/dry space separation of the vehicle door 2. At least one door component 16 of the vehicle door 2, e.g., an electric window lifter, is arranged on the unit carrier 14.

In the following, information regarding the spatial directions is also given in particular in a coordinate system of the motor vehicle (vehicle coordinate system). Here, the abscissa axis (X-axis, X-direction) is oriented along the vehicle's longitudinal direction (direction of travel), the ordinate axis (Y-axis, Y-direction) along the vehicle's transverse direction, and the applicate axis (Z-axis, Z-direction) along the vehicle's height.

The assembly of the door module 6 on the door shell 4 is carried out in two stages. First, the door module 6 is pre-fixed to the door shell 4 in a pre-assembly position V (FIG. 7), and, subsequently, a final assembly is carried out, after which the door module 6 is in a stable and reliable final assembly position on the door shell 4.

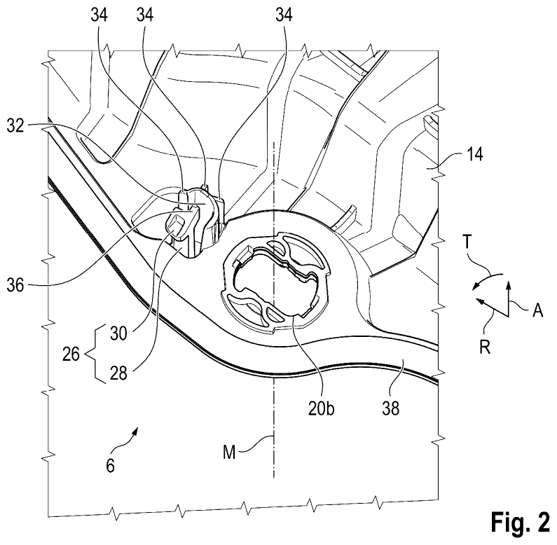

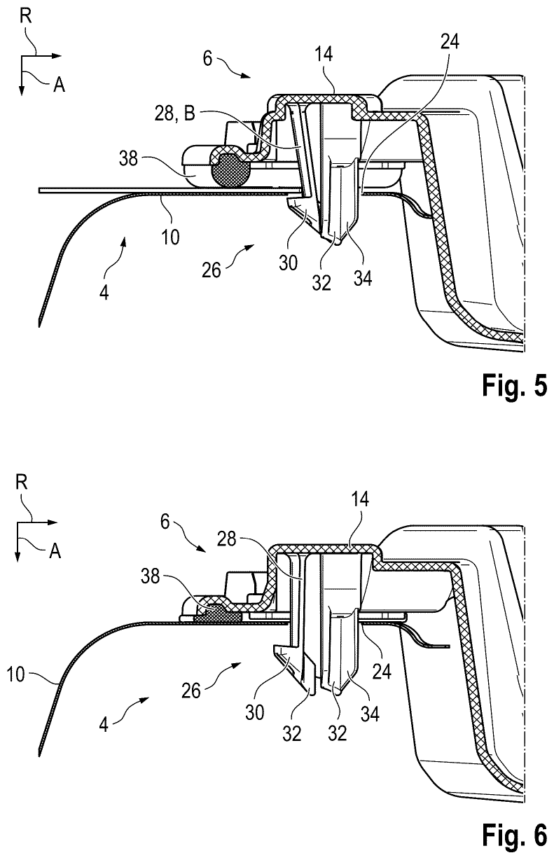

For pre-assembly of the door module 6 on the door shell 4, the door assembly 2 has a connection arrangement 18 (FIG. 4), which is explained in more detail below with reference to FIGS. 2 to 7. The connection arrangement 18 serves for the pre-assembly and mechanical (pre-)connection of two components 4, 6, of which the first component 4 is the door module 6 or its unit carrier 14, and the second component is, for example, the door frame 8 or the inner door panel 10. Accordingly, the unit carrier 14 is also referred to below as the first component, and the inner door part 10 is referred to as the second component.

The components 10, 14 in each case have a (first) through-opening 20a, 20b, wherein the through-opening 20a is introduced into the component 10, and the complementary through-opening 20b is introduced into the component 14. As can be seen, for example, in FIG. 4, the through-openings 20a, 20b of the components 10, 14 exhibit substantially the same opening cross-section.

The through-openings 20a, 20b are provided and configured to make a stable component connection possible in the final assembly position. In the final assembly position, the through-openings 20a, 20b are arranged in a manner axially aligned with one another (FIG. 4) and are penetrated by a connection element 22 joining the components 10, 14. The connection element 22 is pre-mounted on the first component 14 and is at least partially inserted into the through-opening 20b. The connection element 22 is particularly effective in the manner of a bayonet lock to connect the two components 10, 14 to one another or to clamp them against one another.

The following provides information with regard to the spatial directions, in particular with respect to the arrangement of the through-openings 20a, 20b in the final assembly position. Here and in the following, “axial” or an “axial direction A” is understood to mean in particular a direction parallel to (coaxial with) a center axis M passing through the through-openings 20a, 20b, i.e., perpendicular to the end faces of the components 10, 14. Accordingly, here and in the following, “radial” or a “radial direction R” is understood to mean in particular a direction oriented perpendicular (transverse) to the center axis M along a radius of the through-openings 20a, 20b. Here and in the following, “tangential” or a “tangential direction T” is understood to mean in particular a direction along the circumference of the through-openings 20a, 20b (circumferential direction, azimuthal direction), i.e., a direction perpendicular to the axial direction A and to the radial direction R. In the final assembly position, the axial direction A is oriented parallel to the Y-direction, wherein the radial direction R and the tangential direction T are arranged in a plane parallel to the X-Z plane.

The component 10 has a (second) through-opening 24. The second through-opening 24 of the component 10 is arranged to be adjacent to, i.e., close to or at a short distance from, it's through-opening 20. The through-opening 24 is thus arranged in a manner radially offset or distanced from the through-opening 20 on the component 10. As can be seen particularly in the plan view of FIG. 4, the through-opening 24 features an opening cross-section that differs from the opening cross-section of the through-opening 20b. In the embodiment shown, the through-opening 24 of the component 10 is designed in particular as a round hole.

The component 14 has a latching hook 26 projecting axially upwards. The latching hook 26 is preferably formed integrally, i.e., in one piece or monolithically, with the component 14, in particular on a wet-space side. The latching hook 26 has an axially extending latching tab 28, which is provided at its free end with a wedge-shaped latching lug 30.

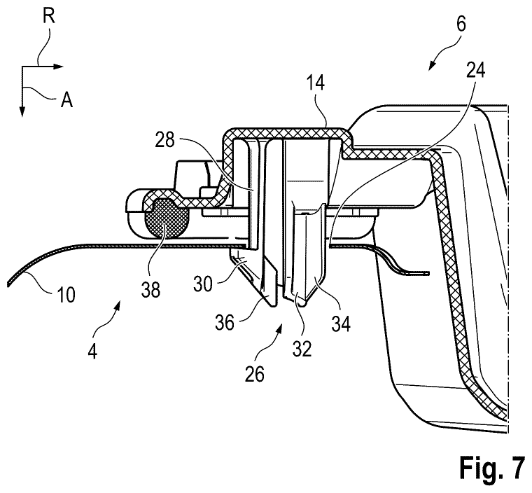

The latching hook 26 or the latching tab 28 is designed to be radially flexible in bending, which means that the latching tab 28 is designed to be able to be elastically deflected in the radial direction R against a restoring force (FIG. 5).

The latching hook 26 is arranged to be adjacent to the through-opening 20b of the component 14. In particular, the radial arrangement of the latching hook 26 relative to the through-opening 20b on the component 14 substantially corresponds to the radial arrangement of the through-openings 20a and 24 on the component 10 (FIG. 4).

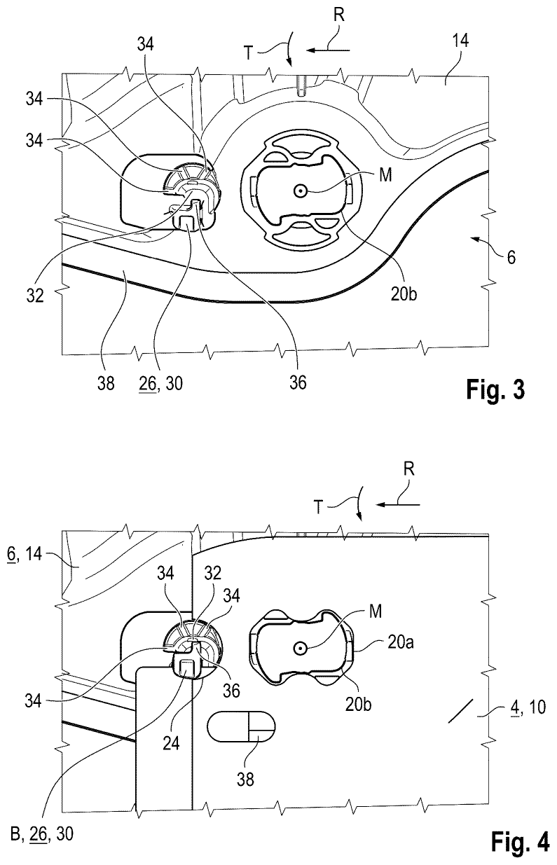

The component 14 has a support wall 32 projecting axially upwards for limiting the radial deflection of the latching tab 28. Here, the support wall 32 is positioned in a manner radially distanced from the latching hook 26 and extends substantially parallel to the latching tab 28. As can be seen comparatively clearly in the plan view of FIG. 3 or FIG. 4, the support wall 32 exhibits an approximately J-shaped cross-sectional shape, wherein, on an outer side, facing away from the latching hook 26, of the J-bend, three, approximately radially oriented, reinforcing ribs 34 are formed, which extend axially upwards along the support wall 32 from the carrier surface of the component 14 toward the outside.

On a rear side, facing the support wall 32, of the latching lug 30, an extension 36 is formed which projects upwards in the direction of the support wall 32. As can be seen in the lateral views of FIG. 6 and FIG. 7, here, the extension 36 also extends axially beyond the latching lug 30. The extension 36 is thus also an axial and radial continuation of the wedge surface of the latching lug 30.

An axially elastically compressible sealing element 38 is also arranged on the component 14. Here, the sealing element 38 is positioned in a manner radially offset from the through-opening 20b and the latching hook 26. In this embodiment, the sealing element 38 is arranged as a carrier seal on the wet-space side circumferentially along an outer edge of the component 14, in order to ensure a seal between the components 10 and 14 or between the wet space and the dry space of the vehicle door in the assembled state (final assembly position). The sealing element 38 is designed, for example, as a PU foam seal (PU: polyurethane) or as a TPE seal (TPE: thermoplastic elastomer).

In the following, a pre-assembly of the component 14 on the component 10 according to the invention is explained in more detail with reference to FIG. 4 to FIG. 7.

In a first assembly step, the components 10, 14 are positioned relative to one another in such a way that the through-openings 20a and 20b, on the one hand, and the latching hook 26 are arranged in a manner axially aligned with the through-opening 24. Here, the latching hook 26 is positioned in such a way that the latching tab 28 is arranged within an inner circumference, projected onto the component 14, of the through-opening 24, and the latching lug 30 is arranged at least partially outside this inner circumference.

In a second assembly step, the component 14 is moved axially in the direction of the component 10. The wedge surface, formed by the extension 36 and the latching lug 30, of the latching hook 26 slides along the opening edge of the through-opening 24, so that the latching tab 28 is deflected radially into a tensioned bending position B (FIG. 4, FIG. 5) until the extension 36 comes to rest against the support wall 32. The mechanical stop of the extension 36 on the support wall 32 prevents, on the one hand, an inadmissible overstretching of the latching tab 28 beyond its elastic range. Here, on the other hand, the supported latching hook 26 also acts as a positioning or centering aid for aligning the components 10, 14 at the opening edge of the through-opening 24.

The latching lug 30—and thus the latching hook 26—is moved radially outwards into the starting position, due to the restoring force of the latching tab 28, as soon as the latching lug 30 or the wedge surface has completely passed through the opening edge of the through-opening 24 (FIG. 6). As a result, the latching lug 30 engages behind the opening edge of the through-opening 24, so that the latching hook 26 is latched or clipped in an axially form-fitting and/or force-fitting manner to the opening edge of the through-opening 24 in a pre-assembly position V.

As can be seen in FIG. 6 and FIG. 7, the sealing element 38 is axially compressed in the course of pre-assembly. Here, the sealing element 38 and the latching tab 28 are axially dimensioned in such a way that the sealing element 38 is at least partially axially compressed in the pre-assembly position V. As a result, the sealing element 38 in the pre-assembly position V produces an axial restoring force, which pushes the component 14 away from the component 10, so that the axial form-fit of the latching hook 26 at the opening edge of the through-opening 24 is secured by means of a tensile stress.

In the pre-assembly position V, the latching hook 26 and the support wall 32 (with the reinforcing ribs 34) are seated radially in the through-opening 24 in a form-fitting and/or force-fitting manner. As a result, in addition to the axial form-fit and/or force-fit, a radial form-fit and/or force-fit is also achieved, which ensures a reliable alignment of the through-openings 20a and 20b in the pre-assembly position V. Here, the latching hook 26 and the sealing element 38 are dimensioned in such a way that, in the pre-assembly position V, an axial distance between the components 10, 14, i.e., an axial clear width, is less than or equal to a penetration length of the connection element 22.

The final assembly of the components 10, 14, i.e., the transfer of the components 10, 14 from the pre-assembly position V to the final assembly position, is subsequently carried out via the first through-openings 20a, 20b and the connection element 22.

The claimed invention is not restricted to the exemplary embodiment described above. Rather, other variants of the invention can likewise be derived therefrom by the person skilled in the art in the context of the disclosed claims, without departing from the subject matter of the claimed invention. All individual features described in connection with the exemplary embodiment can also be combined with one another in other ways in the context of the disclosed claims, without departing from the subject matter of the claimed invention.

In addition, the described solution can be used not only in the specific application case shown, but also in a similar design in other motor vehicle applications, such as door and tailgate systems, window lifters, vehicle locks, adjustable seat and interior systems, and in electric drives, control units, sensors, and their arrangement in the vehicle.

### LIST OF REFERENCE SIGNS

2 Door assembly
4 Door shell
6 Door module
8 Door frame
10 Inner door part, component
12 Assembly opening
14 Unit carrier, component
16 Door component
18 Connection arrangement
20a, 20b Through-opening
22 Connection element
24 Through-opening
26 Latching hook
28 Latching tab
30 Latching lug
32 Support wall
34 Reinforcing rib
36 Extension
38 Sealing element
A Axial direction
R Radial direction
T Tangential direction
M Center axis
B Bending position
V Pre-assembly position

1. A connection arrangement comprising at least a first component and a second component, which in each case have a first through-opening, which are arranged in a manner axially aligned with one another in a final assembly position and are penetrated by a connection element joining the components, having:
a) a second through-opening of the second component, which is arranged to be adjacent to its first through-opening; and,
b) a latching hook projecting axially upwards from the first component and having a radially flexible latching tab and a latching lug at its free end, wherein the latching hook is latched in a pre-assembly position in an axially form-fitting and/or force-fitting manner to an opening edge of the second through-opening.

2. The connection arrangement according to claim 1, wherein the latching hook is dimensioned in such a way that, in the pre-assembly position, an axial distance between the components is less than or equal to a penetration length of the connection element.

3. The connection arrangement according to claim 1, wherein on the first component, an axially elastically compressible sealing element is arranged, which is at least partially axially compressed in the pre-assembly position.

4. The connection arrangement according to claim 1, wherein the first component has a support wall projecting axially upwards for delimiting a radial deflection of the latching tab.

5. The connection arrangement according to claim 4, wherein the latching hook on a rear side facing the support wall has an extension projecting axially upwards as a mechanical stop.

6. The connection arrangement according to claim 4, wherein the support wall has at least one axial reinforcing rib on a rear side facing away from the latching hook.

7. The connection arrangement according to claim 4, wherein in the pre-assembly position, the latching hook and the support wall (are seated radially in the second through-opening in a form-fitting and/or force-fitting manner.

8. A door assembly for a vehicle door, having a door shell and a door module having a unit carrier and a connection arrangement according to claim 1, wherein the door shell has the second component, and wherein the unit carrier is the first component.

9. The door module for the door assembly according to claim 8, having a unit carrier and at least one door component pre-mounted thereon, wherein the unit carrier has a first through-opening that, in a final assembly position, is arranged in a manner axially aligned with a first through-opening of a door shell of the door assembly and is penetrated or can be penetrated by a connection element, wherein the unit carrier has a latching hook projecting axially upwards having a radially flexible latching tab and a latching lug at its free end, and wherein the latching hook is or can be latched in a pre-assembly position in an axially form-fitting and/or force-fitting manner to an opening edge of a second through-opening of the door shell.

10. The connection arrangement according to claim 2, wherein on the first component, an axially elastically compressible sealing element is arranged, which is at least partially axially compressed in the pre-assembly position.

11. The connection arrangement according to claim 2, wherein the first component has a support wall projecting axially upwards for delimiting a radial deflection of the latching tab.

12. The connection arrangement according to claim 3, wherein the first component has a support wall projecting axially upwards for delimiting a radial deflection of the latching tab.

13. The connection arrangement according to claim 5, wherein the support wall has at least one axial reinforcing rib on a rear side facing away from the latching hook.

14. The connection arrangement according to claim 6, wherein in the pre-assembly position, the latching hook and the support wall (are seated radially in the second through-opening in a form-fitting and/or force-fitting manner.

15. The connection arrangement according to claim 6, wherein in the pre-assembly position, the latching hook and the support wall (are seated radially in the second through-opening in a form-fitting and/or force-fitting manner.

16. The door assembly for the vehicle door, having a door shell and a door module having a unit carrier and a connection arrangement according to claim 2, wherein the door shell has the second component, and wherein the unit carrier is the first component.

17. The door assembly for the vehicle door, having a door shell and a door module having a unit carrier and a connection arrangement according to claim 3, wherein the door shell has the second component, and wherein the unit carrier is the first component.

18. The door assembly for the vehicle door, having a door shell and a door module having a unit carrier and a connection arrangement according to claim 4, wherein the door shell has the second component, and wherein the unit carrier is the first component.

19. The door assembly for the vehicle door, having a door shell and a door module having a unit carrier and a connection arrangement according to claim 5, wherein the door shell has the second component, and wherein the unit carrier is the first component.

20. The door assembly for the vehicle door, having a door shell and a door module having a unit carrier and a connection arrangement according to claim 6, wherein the door shell has the second component, and wherein the unit carrier is the first component.
